(19) United States
(12) Patent Application Publication
(10) Pub. No.: US 2009/0158611 A1
(43) Pub. Date: Jun. 25, 2009

(54) Modular Dryer

(75) Inventor: Andreas Ziemann, Potsdam (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH, München (DE)

(21) Appl. No.: 12/226,170

(22) PCT Filed: Mar. 13, 2007
(86) PCT No.: PCT/EP2007/052369

§ 371 Date: Oct. 8, 2008

(30) Foreign Application Priority Data
Apr. 11, 2006 (DE) 10 2006 017 068.7

(51) Int. Cl. F26B 25/08

(52) U.S. Cl. 34/218

(57) ABSTRACT

The invention relates to a dryer which is of modular construction and comprises a process air guide (15, 15′) into which a first air conducting element (161) for forming a condensation dryer (1) or a second air conducting element (16′) for forming a extraction air dryer (1′) may be installed. In the process air guide (15, 15′) is formed an insertion region (15d, 15d′) in which the first (161) or the second air conducting element (16′) is arranged, wherein the two air conducting elements (161, 16′) are designed compatibly in respect of their insertion in the insertion region (15d, 15d′), at least in certain regions.

The invention relates to a tumble-dryer which is of modular construction and comprises a process air guide in which a first air conducting element can be installed for forming a condensation dryer or a second air conducting element for forming an extraction air dryer.

The term “process air guide” covers both a closed process air circuit and an open process air guide. In the case of an extraction air dryer this process air guide is open and the process air is fed into the open after contact with the washing. In the case of a condensation dryer or a circulating air dryer the process air guide is closed and the process air is guided in a closed process air circuit. The process air guide will, in particular, include in the following all the air ducts and components through which process air flows in operation.

DE 42 20 534 A1 discloses a tumble-dryer which can be designed according to both dryer principles that are fundamentally of prior art, namely as a condensation dryer or as an extraction air dryer. If the dryer is designed as a condensation dryer a heat exchanger is arranged in the lower region of the dryer, and if it is designed as an extraction air dryer an air guide is arranged in the lower region, which guide discharges process air via the back of the dryer to the surrounding area. The different designs of this dryer of prior art are conceived independently of each other and have, particularly in the case of the heat exchanger for the condensation dryer and the air guide for the extraction air dryer, very different components which deviate from each other in size and shape. It is therefore also necessary for the further elements of the dryer must be designed differently according to these different variants.

It is therefore the object of this invention to provide a dryer which can be designed in a simple and practical manner either as a condensation dryer or as an extraction air dryer.

This object is achieved by a dryer which has the features according to Claim 1.

A dryer according to the invention is of modular construction and comprises a process air guide in which a first air conducting element can be inserted to form a condensation dryer or a second air conducting element can be inserted to form an extraction air dryer. A common insertion region, in which either the first or second air conducting element is arranged in order to comply with the applicable dryer principle, is formed in the process air guide. Both air conducting elements are designed in such a manner that they are formed so that they are compatible, at least in certain regions, in terms of their installation in this installation region provided.

A dryer may therefore be provided which can be designed simply and practically either as a condensation dryer or as an extraction air dryer. For this purpose essentially only one central element, the air conducting element, is replaceable, and the replacement is carried out quickly and simply due to the compatibility of these two air conducting elements. A much lower development cost than is required for two separate concepts can be achieved, not least because of this compatible modular construction. In addition, the installation of an air conducting element in the installation region is in practice made possible with the same tools and the positioning and arrangement of each air conducting element are essentially the same for both.

The two air conducting elements are preferably each designed compatibly in terms of their insertion in the insertion region. Regardless of which air conducting element is therefore inserted, in particular installed, in the insertion region, the insertion region may therefore remain unchanged. At least one end region of each of the two air conducting elements is therefore designed with such a similarity or equality that it can be mounted on or fitted to an unmodified region of the process air guide. The air conducting elements may therefore be installed with a reduced number of components.

The air conducting element is preferably designed as a heat exchanger, thereby enabling the condensation dryer to be constructed. The process air escaping from the heat exchanger may preferably be conducted via the process air guide to a process air fan. The process air can then be fed on into a drum or a container for receiving articles to be washed by means of this process air fan.

The second air conducting element is preferably designed as an extraction air guide, enabling an extraction air dryer to be constructed in this design. The extraction air guide is preferably arranged so that it leads or opens directly into the area surrounding the dryer with one end.

In a preferred manner the extraction air guide comprises a main duct and a secondary duct, the secondary duct branching from the man duct, and both ducts opening into the area surrounding the dryer. This provides improved discharge of the process air from the dryer.

The main duct and the secondary duct preferably open into the surrounding area on different sides of the dryer. This guarantees at all times safe, reliable discharge of the process air almost independently of the erection of the dryer. Therefore provision may preferably be made for one of the two ducts to open into the surrounding area on one rear side of the dryer and for the second duct to open into the surrounding area on a lateral wall of the dryer. If the dryer is then positioned relatively close to a wall, for example with its rear wall, safe discharge of the process air can then be achieved via the duct which opens into the surrounding area from the lateral wall.

The extraction air guide is preferably designed in one piece. Provision can be made here for the extraction air guide to be formed of plastic, at least in certain regions. If it is formed completely as a plastic component, it may preferably be provided as an injection moulding, thereby guaranteeing low cost production.

Preferably at least the main duct is designed in tapered fashion. The tapering is preferably achieved in such a manner that the end of the extraction air guide opening into the surrounding area has a smaller diameter than the end which is mounted on corresponding elements of the process air guide.

The situation-dependent installed air conducting element is preferably arranged in a bottom group of the dryer.

In the dryer according to the invention essentially only one component, the air conducting element, is replaced and a condensation dryer or an extraction air dryer is therefore provided. On the basis of a condensation eerier in which the air conducting element is designed as a heat exchanger, an extraction air dryer can be formed by simply replacing this with the extraction air guide. All further adaptations are made by omitting components no longer required for the extraction air dryer, such as the cooling air wheel and condensate pump. All the essential components, and particularly the bottom group, therefore remain essentially unchanged.

Exemplary embodiments of the invention are explained in greater detail in the following with reference to diagrammatic drawings, in which:

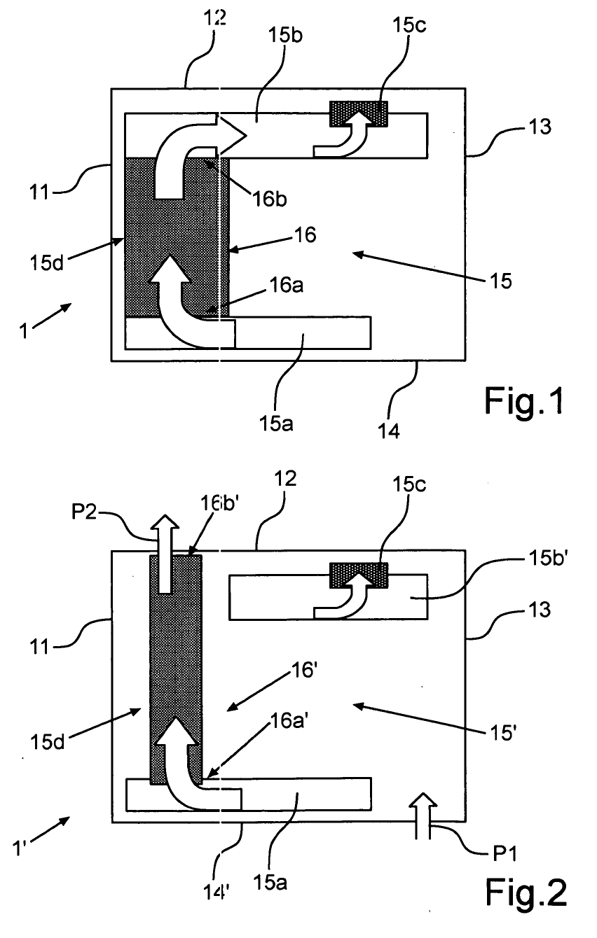

FIG. 1 shows a diagrammatic representation of a dryer which is designed as a condensation dryer;

FIG. 2 shows a diagrammatic representation of a dryer which is designed as an extraction air dryer;

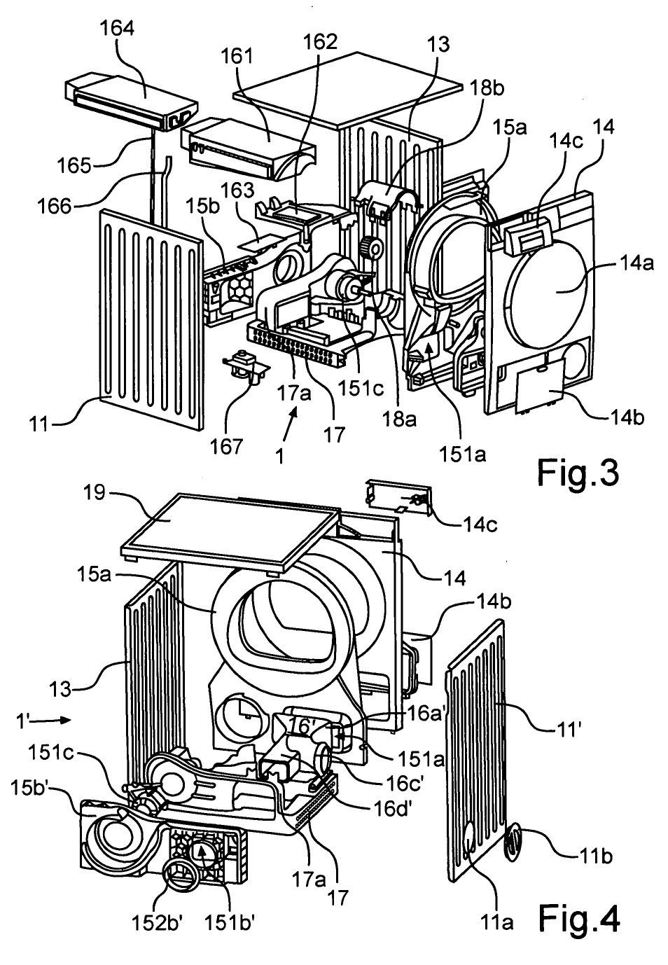

FIG. 3 shows an explosive view of an exemplary embodiment of a condensation dryer, and

FIG. 4 shows an exploded view of an exemplary embodiment of an extraction air dryer.

The same or functionally similar elements are provided in the figures with the same reference symbols.

FIG. 1 shows a diagrammatic elevation of a dryer which is designed as condensation dryer 1. Condensation dryer 1 has a first lateral wall 11, a rear side 12, a second lateral wall 13 and a front side 14. In condensation dryer 1 is arranged a process air guide 15 which is designed as process air circuit 15. Process air is therefore guided in the circuit and flows through a container, not shown (according to normal practice a rotatable drum), in which articles to be washed are placed for drying. Process air circuit 15 has an end plate 15a which is arranged adjacent to front side 14 and, according to normal practice, has a front bearing (not shown) for the container designed as a rotatable drum. It also forms a duct-like part of process air guide 15 for discharging the process air escaping from the container with the articles to be washed. The process air flowing through end plate 15a is fed into a heat exchanger 161 (FIG. 3) of a heat exchanger system 16, which exchanger is designed to dehumidify the process air. Heat exchanger 161 is connected to a further duct-like element 15b of process air circuit 15 in order to guide the process air in a circuit, a process air fan 15c also being arranged through which the process air is in turn conveyed to the container. In the process air guide and process air circuit 15 is formed an installation region 15d in which heat exchanger 161 is inserted, in particular installed. In the construction of condensation dryer 1 heat exchanger system 16, particularly heat exchanger 161, is coupled with a first end 16a for process air guidance to end plate 15a, and with a second end 16b is coupled to element 15b.

Condensation dryer 1 shown diagrammatically in FIG. 1 can be converted simply and practically to an extraction air dryer 1′, as shown diagrammatically in FIG. 2. As can be seen here, only replaceable heat exchanger 161, designed as an air conducting element, is replaced by a second air conducting element, characterised by extraction air guide 16′. This diagrammatically shown extraction air guide 16′ is also arranged in the essentially unchanged installation region 15d. The first air conducting element, in the form of heat exchanger 161, and the second air conducting element in the form of extraction air guide 16′, are in this case designed so that they can be arranged in the one installation region 15d, and are designed compatibly in terms of their installation there. In particular, the first end 16a of heat exchanger system 16 and the first end 16a′ of extraction air guide 16′, are here designed so that they can be joined together with an essentially exact fit with the unchanged installation region 15b and, in particular, the unchanged end plate 15a.

Because of the design as an extraction air dryer 1′, the process air is discharged via the second end 16b′ of extraction air guide 16′ to the area surrounding extraction air dryer 1′. This is denoted by arrow P2. According to arrow P1, the supply air is fed to discharge air dryer 1′. Process air guide 15′ of extraction air dryer 1′ also has, among other things, end plate 15a, as well as element 15b′ and process air fan 15c.

FIG. 3 shows an exploded view of condensation dryer 1, with the essential elements in respect of this explanation. In addition to lateral walls 11 and 13, front side 14 is shown with a feed door 14a. Front side 14 also comprises a flap 14b and an insert 14c. Access to a lint filter, not shown, is gained via flap 14b.

End plate 15a comprises, in the lower region, an opening 151a through which the process air escaping from the container, not shown, is conducted to heat exchanger system 16. This heat exchanger system 16 has heat exchanger 161 and retaining elements 162 and 163. Retaining element 162 here forms part of first end 16a of heat exchanger system 16, and is provided for installation on, or for the mechanical connection to end plate 15a.

In addition, heat exchanger system 16 has a condensate container 164, and a first pipe 165 is also shown which is provided for pumping a condensate into condensate container 164. A further pipe 166 is designed as a return pipe for a condensate. Furthermore, a condensate pump 167 is shown in the representation. Condensation dryer 1 further comprises a bottom group which, among other things, comprises a component 17 and element 15b. A motor 151c, which is designed to drive a fan impeller 18a, is arranged in component 17. Fan impeller 18a and motor 151c are covered by a cover 18b.

FIG. 4 shows an exploded representation of extraction air dryer 1′ in a view from behind. As can be seen here heat exchanger system 16 is replaced there by extraction air guide 16′, which is positioned in installation region 15d. Extraction air guide 16′ is designed, in the exemplary embodiment, as an integral plastic element. As can be seen, first end 16a′ is designed in the shape of a funnel for fitting or installing in installation region 15d. Here this first end 16a′ is designed so that it is compatible with heat exchanger system 16 and, in particular, with support 162 of heat exchanger 161, and can be installed on end plate 15a in the region of opening 151a. As can also be seen, extraction air guide 16′ has a main duct 16d′ and a secondary duct 16c′, which branches from main duct 16d′. Main duct 16d′ and secondary duct 16c′ are in this case designed so that their openings for discharging the process air to the area surrounding extraction air dryer 1′ emerge on different sides of this extraction air dryer 1′. In the exemplary embodiment extraction air guide 16′ is designed and arranged in installation region 15d so that process air is able to escape from rear side 12 via main duct 16d′. For this purpose an opening 151b′ is formed in element 15b′. An annular retaining element 152b′, which allows fastening to rear wall 12 of element 15b′, is arranged on the side of element 15b′ facing away from component 17. Component 17 has an opening 17a through which main duct 16d′ is guided, and extraction air guide 16′ can therefore be arranged and retained with positional accuracy.

Secondary duct 16c′ extends laterally and opens from lateral wall 11′ into the area surrounding extraction air dryer 1′. For this purpose an opening 11a is formed in this lateral wall 11′. If this discharge via secondary duct 16c′ is not required, opening 11a can be covered by a covering element 11b.

As can also be seen in FIG. 4, extraction air guide 16′ is designed so that it is tapered from first end 16a′, particularly in the region of main duct 16d′, as far as second end 16b′.

Extraction air guide 16′ and heat exchanger 161, in particular with its retaining elements 162 and 163, are designed so that they are compatible in terms of installation in installation region 15d. Because of the replacement by the essentially one central element, heat exchanger 161, on the one hand, and extraction air guide 16′ on the other, a corresponding functional principle of dryer 1 or 1′ may therefore be fulfilled, dependent on this. Neither the fitting of these elements on end plate 15a nor their installation in component 17, need be modified in this case.

FIG. 4 also shows a working plate 19 as the upper cover.

In particular, the mechanical fastening of first ends 16a′ and 16a of components 16′ and 16 respectively may be connected with an exact fit to end plate 15a, and here a releasable connection may be provided in the form of cramps. However, a screw connection or the like, or a plug connection, may also be provided.

In comparing condensation dryer 1 with extraction air dryer 1′, parts 161 to 167 and fan impeller 18a, on the basis of the representation in FIG. 3, may be removed for feeding cooling air to heat exchanger 161 as well as to cover 18b. These parts are no longer required for constructing extraction air dryer 1′ according to FIG. 4. Instead of these parts mentioned, parts 16′, 14b, 14c′, 152b′ and optionally 11b′ may be arranged in extraction air dryer 1′ according to FIG. 4. In particular, parts 15b and 15b′, and parts 115c and 11 and 11′ respectively, are then provided in a modified design dependent on the variant constructed.

1-11. (canceled)

12. A dryer, which is of modular construction and comprises a process air guide, into which a first air conducting element for forming a condensation dryer, or a second air conducting element for forming an extraction air dryer, may be inserted, characterised in that in the process air guide is formed an insertion region in which the first or second air conducting element is arranged, wherein both air conducting elements are designed compatibly in respect of their insertion in the insertion region, at least in certain regions.
